(19) United States
(12) Patent Application Publication
(10) Pub. No.: US 2021/0348608 A1
(43) Pub. Date: Nov. 11, 2021

(54) PROGRESSIVE CAVITY PUMP UNIVERSAL JOINT

(71) Applicant: Graco Minnesota Inc., Minneapolis, MN (US)

(72) Inventors: Jonathan R. McMichael, Canton, OH (US); David M. Muckley, Uniontown, OH (US)

(21) Appl. No.: 17/277,919

(22) PCT Filed: Oct. 2, 2019
(86) PCT No.: PCT/US2019/054318

§ 371 Date: Mar. 19, 2021

Related U.S. Application Data
(60) Provisional application No. 62/741,343, filed on Oct. 4, 2018.

(51) Int. Cl. F04C 15/00; F04C 2/107; F16D 3/40; F16D 3/84

(52) U.S. Cl. CPC F04C 15/0076; F04C 2/1073; F16D 2300/12; F16D 3/40; F16D 3/845; F04C 15/0034

(57) ABSTRACT

A progressive cavity pump includes a torque input disposed on a rotational axis, a resilient stator cylinder, a screw rotor situated within the resilient stator cylinder, and a universal joint. The universal joint rotationally couples the screw rotor to the torque input, and includes a swivel block, a linkage, a universal joint coupler, and a fastener. The swivel block has opposite laterally extending trunnions. The linkage extends parallel to the rotational axis, and laterally captures the laterally extending trunnions. The universal joint coupler is disposed around the swivel block and adjacent the linkage. The fastener connects the universal joint to the swivel block. The fastener and the laterally extending trunnions cooperate to transmit torque about the rotational axis through the linkage, while permitting lateral translation of the universal joint coupler in a plane orthogonal to the rotational axis.

### CROSS-REFERENCE TO RELATED APPLICATION

This application claims priority to U.S. Provisional Application No. 62/741,313, which is herein incorporated by reference in its entirety.

### BACKGROUND

The present invention relates generally to fluid pumps, and more particularly to a progressive cavity pump intended for moving a viscous material such as thermal interface material (TIM), and a universal joint for use in such a pump system. In most compositions, TIM is made with 80-90% Aluminum Oxide, which is highly abrasive on mechanical components, including pump components. Fluid-contacting components for systems that pump TIM and similar materials must consequently either be capable of withstanding extremely heavy abrasive wear, or must be replaced frequently. Frequent part replacement increases operating expense, and in many systems also necessitates complex disassembly and reassembly.

### SUMMARY

In one aspect, the present disclosure is directed toward a progressive cavity pump that includes a torque input disposed on a rotational axis, a resilient stator cylinder, a screw rotor situated within the resilient stator cylinder, and a universal joint. The universal joint rotationally couples the screw rotor to the torque input, and includes a swivel block, a linkage, a universal joint coupler, and a fastener. The swivel block has opposite laterally extending trunnions. The linkage extends parallel to the rotational axis, and laterally captures the laterally extending trunnions. The universal joint coupler is disposed around the swivel block and adjacent the linkage. The fastener connects the universal joint to the swivel block. The fastener and the laterally extending trunnions cooperate to transmit torque about the rotational axis through the linkage, while permitting lateral translation of the universal joint coupler in a plane orthogonal to the rotational axis.

In a second aspect, the present disclose is directed towards a universal joint for a progressive cavity pump. The progressive cavity pump can include a torque input situated along a rotational axis, and a screw rotor driven by the rotational axis but situated along an offset rotor axis that orbits the rotational axis. The universal joint includes axially adjacent first and second swivel blocks each having laterally extending trunnions, a linkage extending axially between the first and second swivel blocks, and first and second universal fasteners and joint couplers. The linkage retains the first and second swivel blocks by capturing the laterally extending trunnions. The first and second universal joint couplers are disposed at opposite ends of the linkage and engaged with the first and second swivel blocks, respectively. The first and second fasteners secure the first and second universal joint couplers, respectively, to the first and second swivel blocks, respectively. Each of the first and second swivel blocks is capable of translation in a plane orthogonal to the rotational axis and defined by its own laterally extending trunnions and the first or second fastener, respectively.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a perspective view of a fluid dispensing assembly.

FIG. 2 is a cutaway perspective view of a progressive cavity pump suitable for the TIM dispensing assembly of FIG. 1, and including a universal joint.

FIG. 3 is a cross section view of the progressive cavity pump of FIG. 2.

FIG. 4 is a perspective view of a universal joint for a progressive cavity pump including a protective sleeve.

FIG. 5 is a cross section view of the universal joint of FIG. 4, configured for a progressive cavity pump.

FIG. 6 is a first exploded view of the universal joint of FIG. 4, without a protective sleeve.

FIG. 7 is a second exploded view of the universal joint of FIG. 4, without a protective sleeve.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

The present disclosure is directed principally towards a universal joint for use in a progressive cavity pump for moving thermal interface material (TIM) and similarly viscous and/or abrasive fluids. In particular, this disclosure is especially suited to the pumping of material filled with small abrasive particulates. The disclosure hereinafter refers primarily to the pumping of TIM, but will be understood by a person skilled in the art as generalizable to other materials.

In one embodiment, the universal joint disclosed herein extends along a torque transmission axis, transmitting torque from one end to an opposite end while permitting translation of each end relative to the other, transverse to this axis. The universal joint discussed herein uses at least one swivel block with laterally extending trunnions. In one embodiment, the trunnions of the swivel block are captured by a linkage that can, for example, be formed of two axially-extending joint links. This connection permits the swivel blocks to translate laterally (i.e. radially) relative to the axis, between the joint links, while securing the swivel block circumferentially and axially. In this embodiment, the swivel block is attached to a universal joint coupler by a pin extending through the swivel block and the universal joint coupler. This pin attachment permits the universal joint link to translate laterally (radially) relative to the axis in a direction orthogonal to the degree of freedom introduced by the trunnions. This attachment of a swivel block in this fashion, via a pin and trunnion arrangement, allows torque to be transmitted along the torque transmission axis while permitting a degree of lateral freedom. The aforementioned universal joint can be surrounded by a fluid-tight cover that seals the aforementioned components from TIM, thereby reducing wear from abrasion.

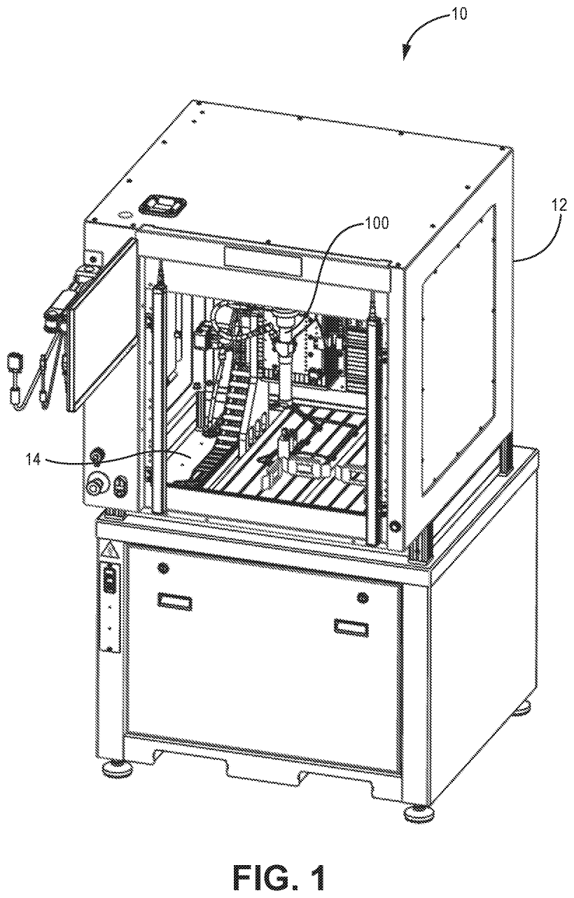

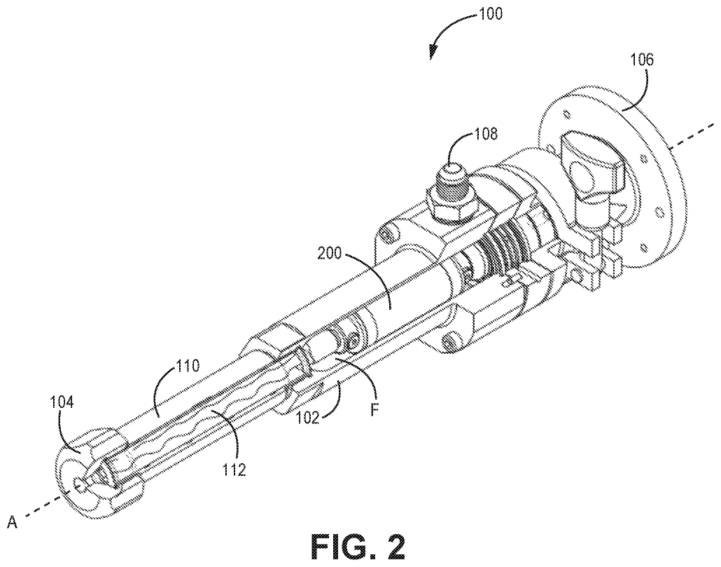

FIG. 1 is a perspective view of TIM assembly 10, which includes housing 12. Housing 12 surrounds workspace 14 and progressive cavity pump 100. TIM assembly 10 is an exemplary system for applying TIM to a substrate within workspace 14. TIM is supplied via progressive cavity pump 100. TIM assembly 10 can be used to apply sections of layers of TIM, which can for example be 80-90% Aluminum Oxide, for thermal coupling between components, e.g. electronic or heat exchange components. Progressive cavity pump 100 and its subcomponents are described in further detail below with respect to FIGS. 2-7.

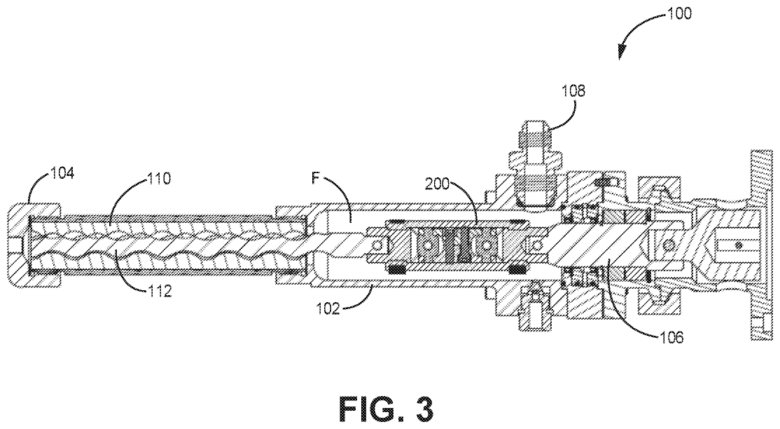

FIGS. 2 and 3 are a cutaway perspective view and a cross-sectional view, respectively, of progressive cavity pump 100. As noted above, progressive cavity pump 100 is a pump capable of moving TIM and other highly viscous or granular materials, including highly abrasive materials. Progressive cavity pump 100 includes housing 102, nozzle 104, torque input 106, fluid inlet 108, stator cylinder 110, screw rotor 112, and universal joint 200, as well as numerous additional un-numbered components and sub-components. Progressive cavity pump 100 extends along axis A, which represents both a fluid flow axis and a torque transmission axis. Housing 102 acts as a rigid enclosure for other components of progressive cavity pump 100, and both serves as the structural framework for progressive cavity pump 100 and defines an interior fluid flow cavity F within pump 100, through which TIM flows during operation of progressive cavity pump 100. Nozzle 104 provides an exit aperture for TIM from progressive cavity pump 100. Torque input 106 receives torque, e.g. from a motor (not shown), and supplies torque to rotor 112 via universal joint 200. Fluid inlet 108 accepts fluid (e.g. TIM) into flow cavity F, and can for example be fed by an external fluid line (not shown) from a dedicated fluid source. Stator cylinder 110 is a resilient, contoured cylinder formed, for example, from rubber or semi-flexible polymer. Screw rotor 112 is a rigid screw-shaped body housed snugly within stator cylinder 110. Screw rotor 112 is coupled to torque input 106 via universal joint 200, which transmits torque while permitting lateral (i.e. radial) displacement of screw rotor 112 with respect to axis A.

During ordinary operation, fluid enters progressive cavity pump 100 via fluid inlet 108, and is pumped towards nozzle 104 by rotation of screw rotor 112 within stator cylinder 110. Screw rotor 112 is driven by torque input 106 through universal joint 200. Torque input 106 rotates on axis A on bearings within housing 102, as shown. By contrast, screw rotor 112 is offset, e.g. by 1-2 mm, from axis A, and orbits axis A while rotating. Specifically, stator cylinder 110 constrains screw rotor 112 such that screw rotor 112 moves about axis A in an orbit that counter-rotates with respect to the rotation direction of screw rotor 112. Universal joint 200 transfers torque from axially-aligned torque input 106 to eccentrically-aligned screw rotor 112, while permitting (only) radial translation of screw rotor 112 as required for screw rotor 112 to orbit axis A within stator cylinder 110. Universal joint 200 is discussed in greater detail below, and is designed to bear heavy torque and off-axis loads with high durability and easy assembly. Universal joint 200 can, for example, be formed of hardened stainless steel, e.g. H900 stainless steel, encapsulated by a flexible cover.

In some embodiments, pump 100 can be configured to use spring loaded triple lip rotary seals. In some embodiments, these seals can be filled with silicone. In most embodiments, fluid inlet 108 is situated close to or immediately adjacent to rotary seals to reduce or eliminate dead area.

As shown in FIG. 3, the inlet of the pump 100 eliminates dead area where the TIM fluid can be trapped. If there exists a dead space where material can collect, as is commonly the case in conventional flexible pump joints, the material will pack out as silicone oil separates from aluminum oxide. This leaves a black powder material that will not allow the pump to freely rotate, requiring a user to service the pump. Filled u-cup seals can be used to help keep TIM out of spring energized seals to extend life.

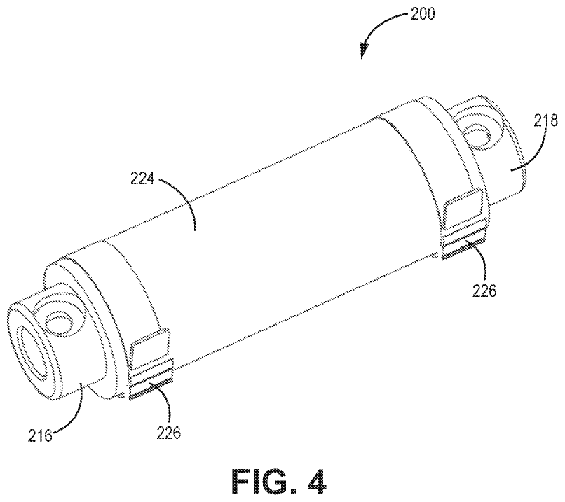

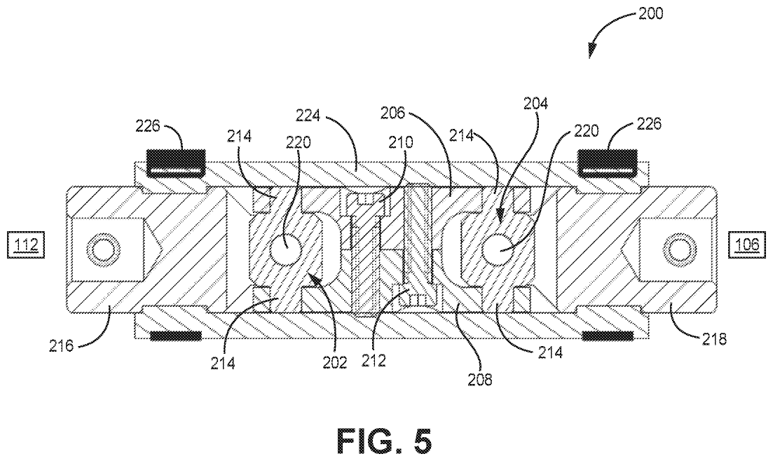

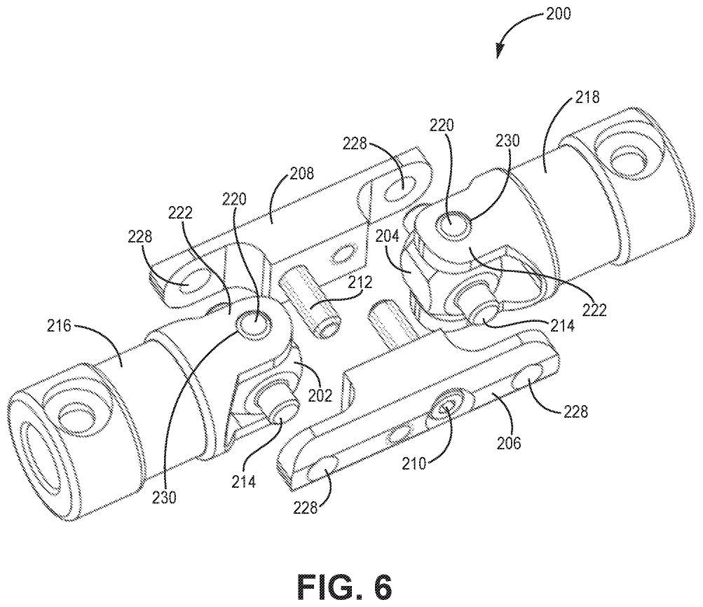

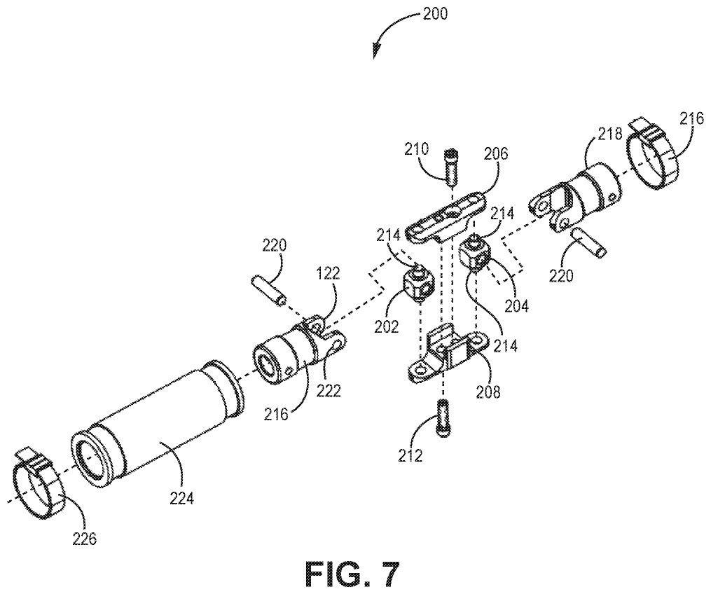

FIGS. 4-7 present various views of universal joint 200. FIG. 4 is a perspective exterior view of universal joint 200, FIG. 5 a cross-sectional view, and FIGS. 6 and 7 exploded views. These figures illustrate components of universal joint 200, including swivel blocks 202, 204, joint links 206, 208, fasteners 210, 212, trunnions 214, universal joint couplers 216, 218, connecting pins 220, attachment arms 222, cover 224, cuffs 226, trunnion receivers 228, and pin receivers 230.

In the illustrated embodiments, swivel blocks 202, 204 are rigid, durable blocks with laterally extending trunnions 214. These trunnions are captured by joint links 206, 208, which are fastened together by fasteners 210, 212 to form a single linkage. Fasteners 210, 212 can, for example, be screws, pins, or similar attachment mechanisms that couple joint link 206 to joint link 208. Joint links 206, 208 are generally axially-extending elements extending axially parallel to each other and to axis A. Joint links 206, 208 have a plurality of attachment holes (discussed below). As shown in FIGS. 4-7, both swivel blocks 202, 204 include laterally-extending trunnions 214 that engage joint links 206, 208 with a degree of lateral (i.e. radial) freedom such that swivel block 202 can translate laterally with respect to axis A, and with respect to swivel block 204.

Universal joint couplers 216, 218 form the mechanical ends of universal joint 200, for attachment to screw rotor 112 and torque input 106, respectively. Universal joint couplers 216 and 218 attach to swivel blocks 202, 204, respectively, via connecting pins 220, such that connecting pins 220 provide a further degree of freedom orthogonal to trunnions 214. Trunnions 214 and connecting pins 220 together provide an orthogonal basis for translation within a lateral plane with respect to axis A, such that joint universal joint coupler 216 (and thereby screw rotor 112) can be rotationally driven by torque input 106 through universal joint coupler 214, while permitting screw rotor 112 to orbit axis A to follow stator cylinder 110.

Swivel blocks 202, 204, joint links 206, 208, and fasteners 210, 212 are surrounded by cover 224. In the illustrated embodiment cover 224 comprises a sleeve secured in a fluid seal to universal joint couplers 216, 218 by cuffs 226, as shown. More generally, cover 224 can take the form of any fluid-sealable exterior element disposed to shield the internal components of universal joint 200 from the flow of viscous, abrasive material such as TIM. In some embodiments, universal joint 200 can be filled with lubricant (e.g. food-grade grease) to extend the life of the joint, and cover 224 can further serve to capture this lubricant. Cover 224 is formed of a resilient material such as neoprene or a similar material that is flexible yet structurally resilient, so as to flexibly follow the relative motion of universal joint coupler 216 with respect to universal joint coupler 218. In at least some embodiments, cover 224 can be an overmolded flexible element formed around other components of universal joint 200, potentially without need for cuffs 226.

In the illustrated embodiment, swivel blocks 202, 204 are connected to universal joint couplers 216, 218 via connecting pins 220, and to joint links 206, 208 via trunnions 214. Specifically, joint links 206, 208 include trunnion receivers 228 to receive trunnions 214, and universal joint couplers 216, 218 include pin receivers 230 to receive connecting pins 220. More generally, trunnion receivers 228 and pin receivers 230 can be holes, slots, or recesses. In alternative embodiments, for example, swivel blocks 202, 204 can be attached to joint links 206, 208 by pins similarly to fastening pins 220.

Universal joint 200 as a whole rotates when driven by torque input 106. Torque is transmitted from torque input 106 to universal joint coupler 216, from universal joint coupler 216 through the linkage formed from link joints 206, 208 into universal joint coupler 218, and from universal joint coupler 218 to screw rotor 212. The movement of swivel blocks 202, 204 within universal joint 200 permits universal joint coupler 216 to translate laterally with respect to universal joint coupler 218, thereby enabling screw rotor 112 to orbit axis A while rotating within stator cylinder 110. Relative to conventional flexible pump joint designs, the design of universal joint 200 with trunnions 214 provides is highly durable, lasting as much as 12 times as long while servicing TIM and similar materials.

### DISCUSSION OF POSSIBLE EMBODIMENTS

The following are non-exclusive descriptions of possible embodiments of the present invention.

A progressive cavity pump comprising: a torque input disposed on a rotational axis; a resilient stator cylinder; a screw rotor situated within the resilient stator cylinder; and a universal joint rotationally coupling the screw rotor to the torque input, the universal joint comprising: a first swivel block having opposite first laterally extending trunnions; a linkage extending parallel to the rotational axis, and laterally capturing the first laterally extending trunnions; a first universal joint coupler disposed around the first swivel block and adjacent the linkage; and a first fastener connecting the first universal joint to the first swivel block, wherein the first fastener and the first laterally extending trunnions cooperate to transmit torque about the rotational axis through the linkage, while permitting lateral translation of the first universal joint coupler in a plane orthogonal to the rotational axis.

The progressive cavity pump of the preceding paragraph can optionally include, additionally and/or alternatively, any one or more of the following features, configurations and/or additional components:

A further embodiment of the foregoing progressive cavity pump, wherein the first laterally extending trunnions and the first fastener permit lateral translation of the first universal joint coupler through sliding translation of the first swivel block relative to the first universal joint coupler along the first fastener, and relative to the linkage along the first laterally extending trunnions.

A further embodiment of the foregoing progressive cavity pump, wherein the first fastener is oriented orthogonally to the first laterally extending trunnions.

A further embodiment of the foregoing progressive cavity pump, further comprising a housing surrounding the universal joint, retaining the screw rotor, and defining an internal flow cavity upstream of the screw rotor, wherein the housing includes a fluid inlet situated to receive a first fluid for pumping.

A further embodiment of the foregoing progressive cavity pump, wherein the universal joint is disposed within the internal flow cavity.

A further embodiment of the foregoing progressive cavity pump, wherein the universal joint further comprises a fluid-sealing cover disposed at its exterior, such that the fluid-sealing cover fluidly separates the first fluid from the first swivel block, the linkage, and the first fastener.

A further embodiment of the foregoing progressive cavity pump, wherein the universal joint additionally comprises lubricant retained within the fluid-sealing cover.

The progressive cavity pump of claim 1, further comprising: a second swivel block disposed axially opposite the first swivel block and having opposite second laterally extending trunnions laterally captured by the linkage; a second universal joint coupler disposed around the second swivel block, adjacent the linkage, and axially opposite the first universal joint coupler; and a second fastener connecting the second universal joint to the second swivel block, wherein the second fastener and the second laterally extending trunnions cooperate to transmit torque about the rotational axis through the linkage, while permitting lateral translation of the second universal joint coupler in a plane orthogonal to the rotational axis.

A universal joint for a progressive cavity pump comprising a torque input situated along a rotational axis, and a screw rotor driven by the rotational axis but situated along an offset rotor axis that orbits the rotational axis, the universal joint comprising: axially adjacent first and second swivel blocks each having laterally extending trunnions; a linkage extending axially between the first and second swivel blocks, and retaining the first and second swivel blocks by capturing the laterally extending trunnions; first and second universal joint couplers disposed at opposite ends of the linkage and engaged with the first and second swivel blocks, respectively; and first and second fasteners securing the first and second universal joint couplers, respectively, to the first and second swivel blocks, respectively; wherein each of the first and second swivel blocks is capable of translation in first and second planes orthogonal to the rotational axis and defined by its own laterally extending trunnions and the first or second fastener, respectively.

The universal joint of the preceding paragraph can optionally include, additionally and/or alternatively, any one or more of the following features, configurations and/or additional components:

A universal joint of the foregoing progressive cavity pump, wherein the linkage is formed from first and second joint links both extending parallel to the rotational axis.

A universal joint of the foregoing progressive cavity pump, wherein the first and second joint links include trunnion receivers disposed to receive the laterally extending trunnions of the first and second swivel blocks with a lateral degree of freedom, thereby axially capturing the first and second swivel blocks between the first and second joint links while permitting lateral movement of the first swivel block relative to the second swivel block.

A universal joint of the foregoing progressive cavity pump, wherein the first and second swivel blocks are captured in the linkage by attachment of the first joint link to the second joint link via a laterally-extending fastener.

A universal joint of the foregoing progressive cavity pump, wherein translation of the first and second swivel blocks in the first and second planes is accomplished by translation of each first or second swivel block relative to the fixture along the laterally-extending trunnions of that swivel block, and by translation of each first or second swivel block relative to a respective first or second universal joint coupler along the respective first or second fastener.

A universal joint of the foregoing progressive cavity pump, further comprising a cover surrounding the first and second swivel blocks, the linkage, and the first and second fasteners in a fluid seal, such that fluid from outside the universal joint cannot reach the first and second swivel blocks, the linkage, or the first and second fasteners.

A universal joint of the foregoing progressive cavity pump, wherein the cover is secured in a fluid-tight seal to the first and second universal joint couplers.

A universal joint of the foregoing progressive cavity pump, wherein the cover is formed of a resilient material capable of flexibly deforming to cooperate with movement of the first universal joint coupler relative to the second universal joint coupler.

A universal joint of the foregoing progressive cavity pump, wherein the cover is a flexible element overmolded about the first and second swivel blocks, the linkage, the first and second fasteners, and portions of the first and second universal joint couplers.

Summation

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A progressive cavity pump comprising:
a torque input disposed on a rotational axis;
a resilient stator cylinder;
a screw rotor situated within the resilient stator cylinder; and
a universal joint rotationally coupling the screw rotor to the torque input, the universal joint comprising:
a first swivel block having opposite first laterally extending trunnions;
a linkage extending parallel to the rotational axis, and laterally capturing the first laterally extending trunnions;
a first universal joint coupler disposed around the first swivel block and adjacent the linkage; and
a first fastener connecting the first universal joint to the first swivel block,
wherein the first fastener and the first laterally extending trunnions cooperate to transmit torque about the rotational axis through the linkage, while permitting lateral translation of the first universal joint coupler in a plane orthogonal to the rotational axis.

2. The progressive cavity pump of claim 1, wherein the first laterally extending trunnions and the first fastener permit lateral translation of the first universal joint coupler through sliding translation of the first swivel block relative to the first universal joint coupler along the first fastener, and relative to the linkage along the first laterally extending trunnions.

3. The progressive cavity pump of claim 2, wherein the first fastener is oriented orthogonally to the first laterally extending trunnions.

4. The progressive cavity pump of claim 1, further comprising a housing surrounding the universal joint, retaining the screw rotor, and defining an internal flow cavity upstream of the screw rotor, wherein the housing includes a fluid inlet situated to receive a first fluid for pumping.

5. The progressive cavity pump of claim 4, wherein the universal joint is disposed within the internal flow cavity.

6. The progressive cavity pump of claim 5, wherein the universal joint further comprises a fluid-sealing cover disposed at its exterior, such that the fluid-sealing cover fluidly separates the first fluid from the first swivel block, the linkage, and the first fastener.

7. The progressive cavity pump of claim 6, wherein the universal joint additionally comprises lubricant retained within the fluid-sealing cover.

8. The progressive cavity pump of claim 1, further comprising:
a second swivel block disposed axially opposite the first swivel block and having opposite second laterally extending trunnions laterally captured by the linkage;
a second universal joint coupler disposed around the second swivel block, adjacent the linkage, and axially opposite the first universal joint coupler; and
a second fastener connecting the second universal joint to the second swivel block,
wherein the second fastener and the second laterally extending trunnions cooperate to transmit torque about the rotational axis through the linkage, while permitting lateral translation of the second universal joint coupler in a plane orthogonal to the rotational axis.

9. A universal joint for a progressive cavity pump comprising a torque input situated along a rotational axis, and a screw rotor driven by the rotational axis but situated along an offset rotor axis that orbits the rotational axis, the universal joint comprising:
axially adjacent first and second swivel blocks each having laterally extending trunnions;
a linkage extending axially between the first and second swivel blocks, and retaining the first and second swivel blocks by capturing the laterally extending trunnions;
first and second universal joint couplers disposed at opposite ends of the linkage and engaged with the first and second swivel blocks, respectively; and
first and second fasteners securing the first and second universal joint couplers, respectively, to the first and second swivel blocks, respectively;
wherein each of the first and second swivel blocks is capable of translation in first and second planes orthogonal to the rotational axis and defined by its own laterally extending trunnions and the first or second fastener, respectively.

10. The universal joint of claim 9, wherein the linkage is formed from first and second joint links both extending parallel to the rotational axis.

11. The universal joint of claim 10, wherein the first and second joint links include trunnion receivers disposed to receive the laterally extending trunnions of the first and second swivel blocks with a lateral degree of freedom, thereby axially capturing the first and second swivel blocks between the first and second joint links while permitting lateral movement of the first swivel block relative to the second swivel block.

12. The universal joint of claim 10, wherein the first and second swivel blocks are captured in the linkage by attachment of the first joint link to the second joint link via a laterally-extending fastener.

13. The universal joint of claim 9, wherein translation of the first and second swivel blocks in the first and second planes is accomplished by translation of each first or second swivel block relative to the fixture along the laterally-extending trunnions of that swivel block, and by translation of each first or second swivel block relative to a respective first or second universal joint coupler along the respective first or second fastener.

14. The universal joint of claim 9, further comprising a cover surrounding the first and second swivel blocks, the linkage, and the first and second fasteners in a fluid seal, such that fluid from outside the universal joint cannot reach the first and second swivel blocks, the linkage, or the first and second fasteners.

15. The universal joint of claim 14, wherein the cover is secured in a fluid-tight seal to the first and second universal joint couplers.

16. The universal joint of claim 14, wherein the cover is formed of a resilient material capable of flexibly deforming to cooperate with movement of the first universal joint coupler relative to the second universal joint coupler.

17. The universal joint of claim 16, wherein the cover is a flexible element overmolded about the first and second swivel blocks, the linkage, the first and second fasteners, and portions of the first and second universal joint couplers.
